(19) United States
(12) Patent Application Publication
(10) Pub. No.: US 2017/0132688 A1
(43) Pub. Date: May 11, 2017

(54) PRICING PRODUCT RECOMMENDATIONS IN A SOCIAL NETWORK

(71) Applicant: Google Inc., Mountain View, CA (US)

(72) Inventors: Martin Brandt FREUND, Mountain View, CA (US); Yuanying Xie, Mountain View, CA (US)

(73) Assignee: Google Inc., Mountain View, CA (US)

(21) Appl. No.: 14/027,125

(22) Filed: Sep. 13, 2013

(51) Int. Cl. G06Q 30/06; G06Q 50/00

(52) U.S. Cl. CPC G06Q 30/0631; G06Q 50/01

(57) ABSTRACT

A system and method is disclosed for pricing a product recommendation made in a social network. A value or reward is determined for a user's recommendation of a product within a social network based on multiple factors, including a level of influence in a social network for the user within a predetermined area of interest, a level of interest in the area of interest for a target audience, and consumer responsiveness to a product category for the product. An auction-related user interface provides vendors of the product the ability to select users tor product recommendations based on a determined impact of those product recommendations and the value or reward to be provided for the recommendations.

### BACKGROUND

Online social networks allow users to interact with each other by posting and sharing messages and images within various message feeds. Members often describe or recommend interesting brands and products (or services) to other members. Some systems generate an influence score for members who may make recommendations based on behavior signals of those members within the social network to determine whether a recommendation will be successful in influencing other members to invest in a brand or product. However, a member's influence alone cannot determine the authenticity of an individual consumer's recommendation in a particular brand or product, or determine how the recommendation might influence other members of the social network to actually invest in the brand or product.

### SUMMARY

The subject technology provides a system and computer-implemented method for pricing product recommendations in a social network. According to one aspect, a computer implemented method may include determining a level of influence for a first user of the social network based on a responsiveness of other users to social activity generated by the first user in the social network, correlating purchase decisions made by social network users with social endorsements related to products in a product category to evaluate consumer responsiveness to the product category, generating, a value for a recommendation of a product in the product category by the first user based on the first user's level of influence and the consumer responsiveness to the product category, and providing the value to a vendor of the product. Other aspects include corresponding systems, apparatuses, and computer program products for implementation of the computer-implemented method.

In another aspect, a machine-readable medium may include instructions stored thereon that, when executed by a processor, cause a machine to perform a method of pricing product recommendations in a social network. In this regard, the method may include determining a level of influence in a social network for a first user within an area of interest based on a responsiveness of other users to area of interest-related social activity generated by the first user in a social network, correlating purchase decisions made by social network users with social endorsements related to products in a product category to evaluate consumer responsiveness to the product category, the product category being related to the area of interest, generating a reward for a recommendation of a product in the product category by the first user based on the first user's level of influence and the consumer responsiveness to the product category, and providing the reward to the first user for the recommendation. Other aspects include corresponding systems, apparatuses, and computer program products for implementation of the machine-readable medium.

In a further aspect, a computer-implemented method may include determining a level of influence in a social network for a first user within an area of interest based on a responsiveness of other users to area of interest-related social activity generated by the first user in the social network, determining a level of interest in the area of interest for one or more second users based on activity initiated within the social network by the one or more second users, generating a reward for a recommendation of a product related to the area of interest based on the level of influence of the first user and the level of interest of the one or more second users, and providing the reward to the first user for the recommendation. Other aspects include corresponding systems, apparatuses, and computer program products for implementation of the computer-implemented method.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 depicts an example system, including an example social pricing engine and example advertising auction engine and corresponding state flow diagram for pricing product recommendations in a social network.

FIG. 2 is a state flow diagram depicting example processes for pricing product recommendations in a social network.

FIG. 3 is a flowchart illustrating a first example process for pricing product recommendations in a social network.

FIG. 4 is a flowchart illustrating a second example process for pricing product recommendations in a social network.

FIG. 5 is a diagram illustrating an example electronic system for use in connection with pricing product recommendations in a social network.

### DETAILED DESCRIPTION

Vendors may incentivize members to recommend products by providing free merchandise or general rewards (e.g., discounts) in specific product areas. In this regard, a member may recommend a brand or product based on the incentive rather than an actual interest in the brand or product. Accordingly, providing an incentive for a member's recommendation cannot guarantee that the recommendation will he successful, much less that the value of the incentive is commensurate with the recommendation.

The subject technology provides a mechanism for determining the value of a brand or product recommendation provided by users in the social network based on predictive factors representative of a likelihood that the recommendation will generate purchase activity. In this regard, a vendor may provide an offering equal to the determined value for the recommendation to a user who has a certain degree of influence within the social network in exchange for broadcasting the recommendation through the social network. For example, the user may be offered a reward (e.g., a discount for a product) in exchange for broadcasting that the user purchased the product or plans to purchase the product.

The system of the subject technology analyzes multiple factors within the social network to determine the value of a recommendation, including, for example, a level of influence of the user providing the recommendation, the size of the user's social graph, the authenticity of the user in making the recommendation, consumer responsiveness to the product or product category associated with the recommendation, and the general interest of the users who may receive the recommendation in the product or product category.

The system may use a combination of two or more of the foregoing factors to determine the value of the recommendation. For example, in determining the value of the recommendation e.g., a discount), the system may calculate the individual weightings of each factor, and then calculate a social conversion score based on the group of weighted factors. The social conversion score may then be used to calculate a product discount or other reward to a user for providing the recommendation. In some implementations, users may access a reward interface (e.g., implemented as a web page) to review their eligibility for discounts or other offerings that may be provided to them from various vendors in exchange for their recommendation of corresponding, brands or products.

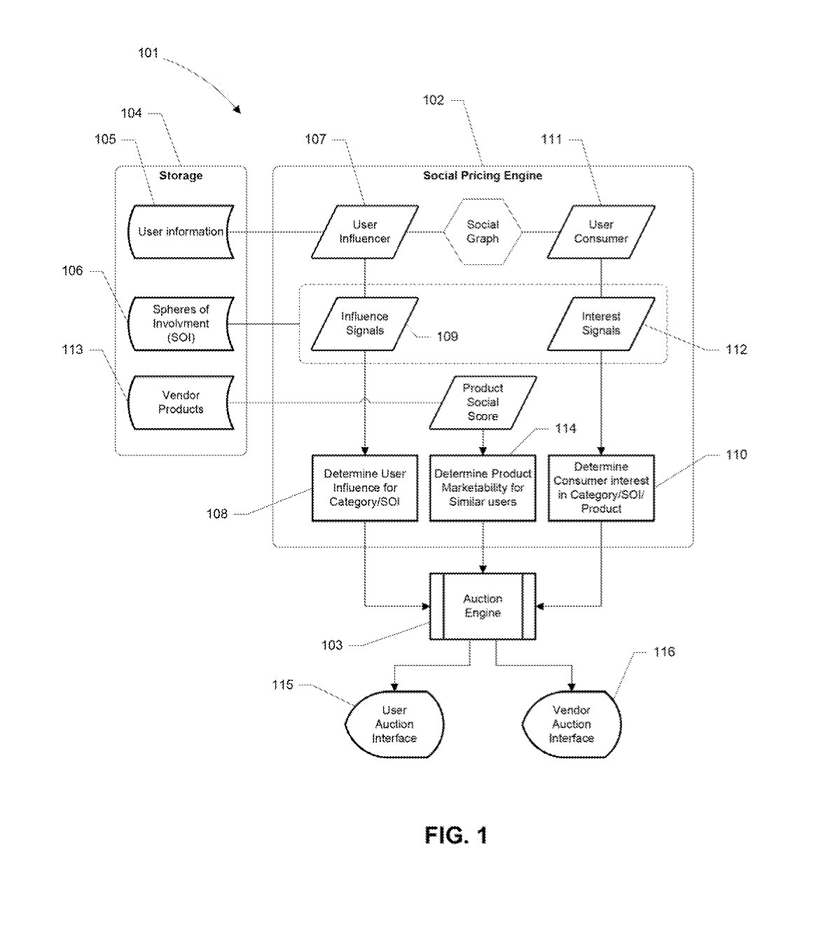

FIG. 1 depicts an example system 101, including an example social pricing engine 102 and example advertising auction engine 103 and corresponding state flow diagram for pricing, product recommendations in a social network, according to various aspects of the subject technology. The blocks of FIG. 1 do not need to be arranged in the order shown. It is understood that the depicted order is an illustration of one or more example approaches, and are not meant to he limited to the specific order or hierarchy presented. One or more blocks of FIG. 1, including social pricing engine 101 and advertising auction engine 103, may be executed by one or more computing. devices. The computing devices may host or operate in connection with one or more social networks.

A storage device 104 stores data related to a social network, including user information 105 for users of the social network. User information 105 includes user profile information for each user, social graph information, and user social activity for each user within the social network. In some aspects, user information 105 may further include information originating or obtained from outside the social network, including browsing activity such as websites visited, articles read, online purchase activity information, and the like. While storage device is depicted as one unit, it is understood that storage device 104 may include multiple databases or storage devices operating in connection with each other or the social network to carry out or support the various implementations and operations described herein.

Although certain examples provided herein can describe a user's social activity or browser history information being stored in memory, the user can delete the information from memory and'or opt out of having the information stored in memory. In example aspects, the user can adjust appropriate privacy settings to selectively limit the types of user information stored in memory, or select the memory in which the information is stored (e.g., locally on the user's device as opposed to remotely on a server). In example aspects, the stored information does not include and/or share the specific identification of the user (e.g., the user's name) unless otherwise specifically provided or directed by the user.

Storage device 104 further stores categories or spheres of involvement (SOI) 106 for the users of the social network. SOIs include (and may be described herein as) “areas of interest” that may be attributed, to one or more users of the social network, including an interest in one or more geographic locations or areas, business establishments (including companies and restaurants), movies, music, sports (e.g., sports teams, memorabilia, or types of sports), and other tangible or intangible things.

A SOI may be determined for a user from one or more signals present in user information 105. For example, a SOI may be based on a geographic location data provided by the user to the social network (e.g. through check in data), categories in a profile, cookie data, topics of posts and pictures, celebrities of entertainment entities followed by the user in the social network, endorsements, demographic of the user or friends of the user, age, gender education or university attended, work history, online purchases and the like. A SOI may be determined for a user based on information provided in connection with, or derived from, social activity of the user. For example, social pricing engine 102 may determine that a post to a social stream is related to a SOI based on a comparison of keywords in the post to predetermined index of SOIs, or analysis of an image (e.g., a digital photo or video) posted to a social stream by computer vision/image recognition or optical character recognition to generate the keywords for comparison.

Social pricing engine 102 determines SOI influence score 108 for each SOI of user. SOI influence score 108 measures the user's influence within the SOI based on one or more influence signals 109 related to the SOI. Influence signals 109 may include general influence signals including the size of the user's social graph (e.g., number of friends and/or followers of the user), frequency of the influencer being referenced by other users (e.g., tagged with contacts in posts, images), frequency of visits to the user's social profile, frequency of comments and endorsements on the user's social activity within the social network (e.g., on images or posts), frequency of responses and response times to the user's social activity, and the like. These general influence signals may be aggregated to create a general influence score (or base score) for determining an overall influence score for the user in the social network (which may include within one or more SOIs). Accordingly, each signal may have a specific signal value that is computed with other signals using a predetermined algorithm to generate a base influence score. This base influence score may be aggregated with other factors or adjusted to generate SOI influence score 108.

Influence signals 109 may also include stronger SOI-specific signals, including any of the foregoing signals that are determined to he related to the SOI. In this regard, social pricing engine 102 may first determine that a post to an activity stream by a user influencer 107 is related to the SOI, and then determine SOI influence score 108 based on signals related to the post SOI-specific signals may also include the frequency of the user influencer making posts related to a SOI, a number of groups that the user is part of that related to the SOI and frequency of social activity within those groups, geographic proximity to an area related to the SOI (e.g., the user resides within the same city), the frequency of posts and/or messages to or from the user (e.g., messages to the user may be more important than those from the user), frequency of visits (e.g., by browser navigation) to external links, articles, promotional sites related to the SOI, and the like.

One strong SOI-specific signal may include how many how many social connections (e.g., social contacts/friends/connections/followers) a user influencer 107 has that have been determined to be involved in the SOI. Additionally, social pricing engine 102 may determine an aggregate influence score within an SOI for all the user's connections within a predetermined degree of separation in the user's social graph. These previously described stronger SOI-specific signals may be used to exclusively determine SOI influence score 108, or used to augment the previously described base influence score for user influencer 107.

SOI-specific signals may also be used to adjust the value of one or more of the previously described social activity signals, or a base influence score or SOI influence score 108, In some aspects, the value of each post related to a SOI may be determined based on the number of posts made that are related to the SOI and/or the social network in general. For example, the value may become reduced or diluted as more posts are made with regard to the SOI. In one example, the SOI score for the SOI is increased if the user makes less than a predetermined maximum portion of posts related to the SOI compared to other posts within a period of time, but more than a predetermined minimum portion of posts. In other aspects, the value of a social activity signal may be based on the time period in which the corresponding social activity was performed. For example, the value of a post related to a SOI on the total aggregate score may decrease over time. In the same regard, a connection or contact made between a friend or other user within a social graph may be less relevant (and have less value) as becomes more distant in time.

In various implementations, advertising auction engine 103 receives SOI influence score 108, along. with One or more other scores to facilitate an online advertising auction between vendors/advertisers, user influencers, and target audiences. Accordingly, social pricing engine 102 generates a consumer interest score 110 representative of interest in various SOIs for user consumers or groups of consumers. In this regard, the value of a user's influence within a SOI may be generated with respect to user consumers 111 who are interested in the same or related SOI.

Social pricing engine 102 analyzes SOI influence signals 109 and SOI interest signals 112 (signals related to an interest of a user in a SOI) for each user in the social network. The strength of these signals may be used to categorize each user's disposition as a user influencer 107, a user consumer 111, or both.

A user's consumer interest score 110 for a SOI may be determined by the strength of the corresponding signals in user information 105 contributing to the determination the SOI. For example, consumer interest score 110 may be based on the number or calculated value of information related to the SOI, including geographic location data, categories in a profile, cookie data, topics of posts and pictures, celebrities or entertainment entities followed by the user, endorsements, demographic of the user or friends of the user, age, gender education or university attended, work history, online purchases, and the like.

Storage device 104 may further store predetermined vendor products 113. The term “vendor products” is used herein to describe products, services, and brands provided by a particular vendor or group of vendors. In this regard, social pricing engine may include a product marketability score 114 for each product stored in storage device 104. Products may be organized by product category (e.g., apparel, home audio, camcorders, handbags, and the like), and product categories may be associated with one or more SOI. For example, a SOI related to soccer sports may include soccer jerseys, soccer shoes, protective gear, soccer or general sports memorabilia, and the like.

Product marketability score 114 may be entered manually for each product (or product category), provided by the vendor other service, or determined dynamically based on, for example, historical online and online, data (e.g., from click-through data for advertisements related to the product, anonymous user purchase activity data from an online payment service or consumer website, and the like). Product marketability score 114 is representative of the likelihood that a user may be influenced by a social recommendation to purchase a product or one or more of a group of products in a product category.

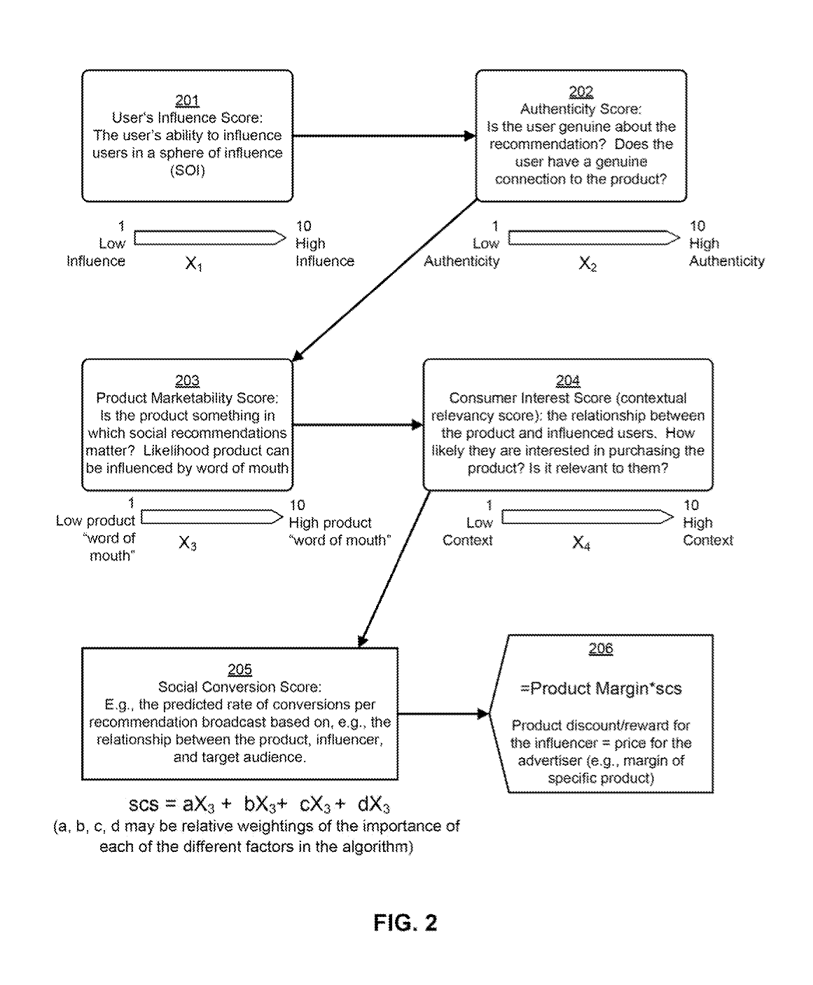

Auction engine 103 may comprise a website or group of websites that provide one or more user interfaces over a network (e.g., over the Internet, private LAN). Auction engine 103 receives a plurality of SOI influence scores 108, consumer interest scores 110, and product marketability scores 114 to generate an online auction. As will be described further, social pricing engine 102 may also determine an authenticity score (see, e.g., FIG. 2) representative of the authenticity of a user's influence within a SOI as input to auction engine 103. Accordingly, auction engine 103 may pull the respective scores from storage device 104 to generate auction listing, or other information related to user influence or consumer interest in one or more products or product categories.

Vendors may want to compensate users for broadcasting their products to social connections (e.g., friends and family) through one or more social networks. A vendor, for example, may find it more valuable for a user to talk about the vendor's product than to actually pay for it. Accordingly, auction engine 103 provides a formalized way of incentivizing users to market their products through their social graphs and at the same time provide a value each user's recommendation with respect a specific product, group of products, and/or target audience.

Auction engine 103 provides a user auction interface 115 for use by user influencers 107 to identify or receive incentives provided by various vendors for making recommendations to other users within their social graph. User auction interface 115 may include one or more webpages that display a user influencer's influence score 108 for one or more SOIs, in addition to incentives available to the user from vendors for product recommendations within those SOIs. Similarly, auction engine 103 provides a vendor auction interface 116 for use by vendors to identify user influencers that may be available to make recommendations and the value those recommendations. In various implementations, user influencers are anonymized, displayed or ordered by influence score within a specific SOI.

Through auction engine 103 user influencers may loin an auction in which they are compensated for making product recommendations. Once a user influencer has indicated interest in making a recommendation through user auction interface 115, a vendor may select to compensate the user for making the recommendation through vendor auction interface 116. In sonic aspects, user influencers may increase or decrease their value within a SOI to attract vendors or maintain a competitive market price for their recommendation, and vendors may increase the incentive value they are willing to compensate user influencers for recommendations.

The invention allows the vendor to have anonymized insight into the user's social graph and can determine the users' sphere of influence in helping to promote their specific product. For example, a user who is highly influential (e.g., has a large social graph and number of connections) may be offered a greater reward than someone who has a smaller sphere of social influence. The vendor may also offer product discounts for a product based on the composition of the user's social graph and the user's SOI with respect to the product. For example, if the vendor is selling baby clothes, a user who is friends with many mothers may be offered a product discount. In other aspects, users with contacts/friends in certain geographic locations, work places, schools, affiliations, interests, demographics, “importance” of connections May be offered discounts or other incentives (e.g., cash payment) for making a product recommendation.

In one or more implementations, various components of system 101 may be integrated with a consumer website to provide incentives in connection with purchases made on the website. For example, a user may navigate to a popular brand's vendor website or social. network webpage. The vendor is offering a new pair of soccer shoes. Social pricing engine 102 determines that the user has a certain degree of influence with a SOI related to the soccer shoes. The user clicks to buy the shoes, and is offered the option of making a “social purchase.” Social pricing engine 102 determines that the user is connected to 93 friends who are soccer enthusiasts (and, e.g., these soccer enthusiasts on aggregate have 312 soccer enthusiast connections, and the like), and that these connections may be potential buyers of the shoe. Because of the composition of the user's social graph, the user is offered a 35% discount in exchange for posting the purchase of the shoes to his social stream where it will he visible to his soccer friends. Accordingly, the vendor gets targeted word of mouth for its shoes, and the user enjoys a discount on a new pair of shoes.

Many signals may be tracked at the product level. Because some products are more prone to network effects than others, certain signals may be used to get insights into which products should be discounted more relative to others. For example, women in a certain demographic may be more likely to be influenced more by a friend's purchase of perfume because “it reveals more about their personality” than from a soap purchase. Accordingly, women influencers in the same demographic may receive a better discount on the perfume for sharing a perfume purchase in their social stream.

FIG. 2 is a state flow diagram depicting example processes for pricing product recommendations in a social network, according, to various aspects of the subject technology. In the depicted example, a product reward is generated for a user based on multiple factors or scores as input into a predetermined reward algorithm. Blocks 201 to 204 each represent an example factor, while block 205 is representative of an example reward algorithm. While four primary factors are depicted as input to the reward algorithm, it is understood that other factors may be included or some factors omitted.

Each factor may be generated based on one or more signal values, with each signal value being generated based on one or more signals. Signals are determinable events or indications received by system 101, or generated based on analysis of events or indications. An example signal may be an observable occurrence that is either true or false, for example, whether a message was posted to a social stream, an endorsement occurred, a page or post was viewed, and the like. An instance of a signal (e.g., that an event is true) may be equated to a predetermined instance value, and a corresponding signal value generated based on an aggregation of the instance values for a plurality of signals (e.g., by adding 1 for each instance). The aggregated signals may be scaled or weighted to generate a signal value that is consistent with other signal values used in generating a primary factor. In some aspects, a number of instances of the same type of signal (e.g., a number of endorsements) may be accumulated (e.g., summed together) and then scaled or weighted to represent the instances as a whole, added to other signal values, and then further scaled or weighted.

Additionally, the example product reward generated by FIG. 2 corresponds to a single user influencer's recommendation of a single product or SOI to one or more user consumers. The product reward may be generated (e.g., by system 101) for display at user auction interface 115 to inform the user accessing the interface of the rewards available to the user for making recommendation of certain products. The product reward may also be generated for display at vendor auction interface 116 for multiple users to inform a vendor accessing the interface of which users are available to recommend the vendor's products, the potential scope and/or impact of each user's recommendation (e.g., measured in size of social graph and influence score within the SOI corresponding to a product), and the size of the user's target audience (e.g., measured in the size of the user's social graph).

In block 201, a process (e.g., social pricing engine 102 operating on one or more computing, devices) determines a SOI influence score 108 for a user. As described previously, SOI influence score 108 is representative of a user's influence with respect to a particular SOI. In this regard, a level of influence may be determined for the user based one or more of the previously described influence signals 109 for a SOI, to represent a responsiveness of other users to SOI-specific social activity generated by the user in the social network. SOI influence score 108 may be a scaled number (e.g. from 1 to 10, a percentage, or the like) that represents a influence range between low influence and high influence.

When determining whether a vendor wants to have a user broadcast one or more recommendations of products to the user's friends through as social network, the vendor may consider whether the user is a good influencer based on the size of the user's social graph and the user's sphere of influence. For example, a user may have an extremely large social graph (e.g. one million followers), but the user's product recommendation may not perceived as genuine to other users; the recommendation may be perceived to be comparable to a paid advertisement. In this example, the conversion rate may be much lower, and a vendor may overpay for the social recommendation.

Accordingly, block 202 includes a process for determining, an authenticity score of a user influencer 107. The authenticity score measures a user's authenticity relative to a SOI or specific. product recommendation. This authenticity score ultimately helps a vendor decide how much to value an influencer's recommendation in the following areas: (1) how genuine the connection between the influencer and the product is perceived to be by other users, (2) how likely the recommendation is to be taken seriously by other users, and (3) how convincing the recommendation is to other users.

The process of block 202 includes an authenticity algorithm that determines the authenticity score based on signal values based on one or more of (1) a connection between the user and recommended product, (2) a frequency and focus of the user's past social recommendations that are related to the product or SOI, and (3) the role model power of the user in relation to the recommended product.

In determining the connection between the user and recommended product, the authenticity algorithm measures the user influencer's interaction/experience with the product. The more tightly linked a user influencer is to a product (e.g., they have used the product before or have shown a natural interest in it in the past), the more likely the recommendation may seem to be genuine. For example, the user actually used the product before or is the user recommending it because the user really believes in the product? Has the user demonstrated a genuine interest, in the product based on measurable activity, for example, through searches, taking, and uploading images, visiting websites or other retail presence for the product, and the like?

Signals for determining the connection between the user and the product include, for example, browser/cookie history (e.g., has the person looked at pages related to the product), clickstream data (e.g., has the person clicked on ads related to the product), social network activity (e.g., has the shared or read content about the product), images and videos (e.g., has the person taken images or videos with the product and/or interacted with it), social endorsements (e.g., has the person expressed interest in the product to other users in a social network), purchase history through online services, including the purchase of competing products which may nullify the user's credibility for recommending the product to others. Each of the foregoing signals present (e.g., in user information 105) may be, for example, given a certain value (e.g., positive or negative), aggregated or summed together, and then the scores averaged or weighted to generate an overall “connection signal value” for the user and product.

The subject technology also measures the user influencer's frequency and range of focus in past posts, and adjusts the authenticity score for a certain product lower if the user has recently recommended, for example, a competing product or very different product. The more limited and more focused a user influencer's past recommendations are, the more likely it may be for a similar product recommendation to be perceived as genuine and convincing. In some aspects, the more broadcasts, posts, or recommendations made in a certain period of time, the less value each broadcast, post or recommendation has during that period of time. Moreover, if the user posted a recommendation for a product and then posted a subsequent recommendation of a competing product the recommendations may not he perceived as authentic.

Signals for determining the frequency and focus of user's past social recommendations may include, for example, social network activity of the user (e.g., how often has the person recommended other products, which products were recommended, similarity in products, and whether recommendations were made for competing products), and the user's interaction with images and posts (how often has the user posted or commented on the product, similar products, or competing products). Signals positively directed toward the product itself may have a favorable impact on the authenticity score, while signals positively directed toward competing products may have a negative impact. Each of the foregoing signals present (e.g., in user information 105) may be, for example, given a certain value (e.g., positive or negative), aggregated or summed together, and then the scores averaged or weighted to generate an overall “focus signal value” for the user and product.

The more a user is perceived as a role model (e.g., someone that other users want to emulate), the more that user's recommendations for products in a particular SOI will be valued. For example, a soccer play may not just be an authority on soccer, so as to be perceived as an expert in soccer shoes. The soccer player may impart celebrity status, such as that people wear the shoes that the player recommends as part of aspiring to be like the soccer player.

Signals for determining the role model power of a use in relation to a product may include, for example, search algorithm rankings (e.g., whether the user's blog or website about a certain topic have a high page rank), online news stories about or related to the user (e.g., whether the user show up in news articles associated with the product), endorsements and interest by others (e.g., whether the user's posts or images related to the product or SOI heavily commented on and re-shared within the social network), and the like. Each of these signals (e.g., present in user information 105) may be, for example, given a certain value (e.g., positive or negative), aggregated or summed together, and then the scores averaged or weighted to generate an overall “role power signal value” for the user and product.

The process of block 202 aggregates the previously described connection signal value, focus signal value, and role power signal value for a user and a product to generate the authenticity score. The authenticity score may be a scaled number (e.g., from 1 to 10, a percentage, or the like) that represents a range between low authenticity and high authenticity. The authenticity score provides an indicator of the likelihood that user consumers receiving a recommendation from a user influencer will feel that the recommendation is genuine.

In block 203. a process (e.g., social pricing, engine 102 operating on one or more computing devices) determines a product marketability score 114 for a product. The subject technology provides vendors a formalized automated way of determining which products are worth being recommended and are marketable (i.e. they spread easily through “word of mouth”) and which products aren't very socially marketable. For example, a recommendation for dishwashing fluid may not be as socially powerful as a recommendation for the latest line of jeans.

Accordingly, the subject technology generates product marketability score 114 for a product to indicate the produces social marketability (e.g., the product's ability to spread through word of mouth), Product marketability score 114 is based on an input of one or more factors that may help the merchant decide how much to value a social recommendation for a given product, including (1) whether the product is in a category in which social recommendations matter, (2) the likelihood that a user could be influenced to purchase a the product based on a social recommendation, (3) the social “stickiness” of the product, and (4) the perceived scarcity of the product.

Generally, the more that people share or recommend a product, the stronger the product's connection with social recommendations, and the greater “word of mouth” power the product has. One indication of this connection is whether the product is in a category in which social recommendations matter, which may be based upon whether the product (or corresponding SOI) is frequently posted or talked about on the social network, how many online searches for the product were made within a predetermined period of time, whether users are commenting on blogs/posts/articles related to a topic or SOI for the product and the nature of those conversations (e.g., whether they specifically mention the product), whether users endorsed content related to the product, and whether users are purchasing products as a result of clicking an advertisement related to the product, and whether the advertisement or product was previously endorsed by other users in the user's social graph.

Signals for determining a product's connection with social recommendations may include, for example, search activity related to the product or related SOI initiated within a predetermined period of time after the user viewed a social interaction regarding the product, the purchase of keywords related to the product for online advertising purposes, sharing of content related to or about the product, endorsements of the product, and the like. Each of these signals may he for example, given a certain value (e.g., positive or negative), aggregated or summed together, and then the values averaged or weighted to generate an overall “market connection signal value.”

The more users that are determined to have bought a product after hearing about the product from someone else, the more likely other users may be influenced to buy the product by future recommendations. Accordingly, the likelihood that a user could be influenced to purchase the product based on a social recommendation may be based on measuring a users purchase history in relation to product recommendations. For example, whether the user has made purchasing decisions (e.g., indicated by online purchase activity) in the past after seeing a social recommendation for the product, and to which recommendations were most likely to cause generate purchase activity and which did not.

Signals for determining influence of social recommendations may include, for example, an indication from a user's purchase history (e.g., generated from a payment service) that the user bought the product or a competing product, an indication that the user clicked on an advertisement after viewing a product recommendation or endorsement, the number of other users in the user's social graph that have recommended the product in the past, and whether those other users are family or friends of the user or a celebrity. Each of these signals may be, for example, given as certain value (e.g., positive or negative), aggregated or summed together, and then the values averaged or weighted to generate an overall “social influence signal value.”

The easier it is for users to switch to a new product after seeing a recommendation, the more effective recommendations for the product may be. Accordingly, the subject technology determines a “social stickiness signal value” for a product based on a number of signals, including the number of purchases or recommendations made within a user's social graph before the user initiates purchase activity related to the product, for example, by navigating to a website related to purchasing the product, clicking on an advertisement for the product, inquiring about the product through a post to a social stream. Another signal may include the amount of time between the user's viewing of a recommendation and when the user initiates the purchase activity. The social stickiness signal value may be used, for example, in determining product marketability score 114.

The perceived scarcity of the product may be determined by multiple signals including, for example, inventory levels captured from e-commerce websites and pages for the product, online advertising keyword purchases for the product (e.g., the number of keyword buys may experience seasonal fluctuations), and the number of advertisements exposed to the user or group of users over a predetermined period of time. For example, social pricing engine 102 may determine how many advertisements were displayed within the social network for a particular product over the past month. Each of the foregoing signals may be, for example, given a certain value (e.g., positive or negative), aggregated or summed together, and then the values averaged or weighted to generate an overall “perceived scarcity signal value.”

The process of block 203 aggregates the previously described market connection signal value, social influence signal value, social stickiness signal value, and perceived scarcity signal value for as product to generate product marketability score 114. Product marketability score 114 may be a scaled number (e.g., from 1 to 10, a percentage, or the like) that represents a range between low product “word of mouth” and high product “word of mouth.” Product marketability score 114 may also be generated for a SOI by correlating the previously described signal values for a plurality of users with respect to the SOI.

In block 204, a process determines a consumer interest score 110 for a product or SOCI for each user consumer 111. As described previously, consumer interest score 110 is representative of a user's interest in a product or SOI in general, and may be based on the user's social activity related to the product within the social network. Accordingly, consumer interest score 110 may be generated based on one or more of the foregoing SOI interest signals 112 for each user of the social network.

In block 205, system 101 generates a social conversion score (“scs”) for a product. The social conversion score may be based on one or more of the previously described scores. The social conversion score is a metric which indicates the predicted rate of conversions per recommendation broadcast based on the relationship between the product, user influencer 107, and a user consumer 111 or other target audience. In the depicted example, the social conversion score (“scs”) is generated using the equation:

scs=aX₁+bX₂+cX₃+dX₄ (1)

where X₁ is SOI influence score 108. N₂ is the previously described authenticity score, X₃ is product marketability score 114, and X₄ is consumer interest score 110, and a, b, c, d are relative weightings of the importance of each of the different scores/factors in the equation.

In block 206, system 101 generates a product reward for user influencer 107. In the depicted example:

product reward=(Product Margin)*scs (2)

The product reward may be used to generate a discount for the product, for example, by setting a new product margin for the product for a vendor. The reward may be displayed as a discount percentage off a retail price for the product. Accordingly, system 101 generates the product reward for each product or product category or SOI and user influencer/consumer combination displayed at user auction interface 115 or vendor auction interface 116.

According to one or more implementations, one or more blocks of FIG. 2 may be executed by machine or computing device implementing social pricing engine 102 and/or auction engine 103. Similarly, a non-transitory machine-readable medium may include machine-executable instructions thereon that, when executed by a machine or computing device perform the blocks of FIG. 2. It is understood that the depicted order of the blocks is an illustration of one or more example approaches, and are not meant to be limited to the specific order or hierarchy presented. The blocks may be rearranged, and/or two or more of the blocks may be performed simultaneously.

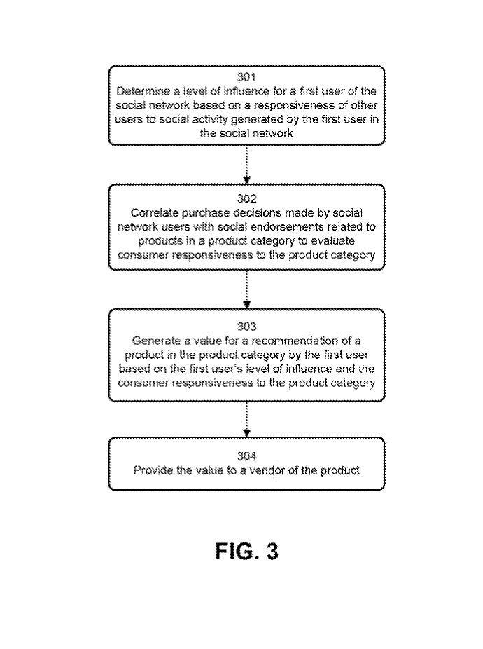

FIG. 3 is a flowchart illustrating a first example process for pricing product recommendations in a social network, according to one or more aspects of the subject technology. The blocks of FIG. 3 do not need to be performed in the order shown. It is understood that the depicted order is an illustration of one or more example approaches, and are not meant to be limited to the specific order or hierarchy presented. The blocks may be rearranged, and/or or more of the blocks may be performed simultaneously.

According to one or more implementations, one or more blocks of FIG. 3 may be executed by one or more computing devices implementing system 101, including social pricing engine 102 and/or auction engine 103. Similarly, a non-transitory machine-readable medium may include machine-executable instructions thereon that, when executed by a computer or machine, perform the blocks of FIG. 3.

In block 301, a level of influence is determined for a first user of the social network based on a responsiveness of other users to social activity generated by the first user in the social network. For example, when the first user posts a message or image to a social stream the number of users that respond to the post and the time period for those responses will indicate a certain level of responsiveness. Responses may include users viewing the post, clicking on a link associated with the post, posting a reply message or image, sharing the post with others, endorsing the post, and the like. The greater the responsiveness of the other users to a post, the greater the level of influence of the first user for that instance. Accordingly, multiple instances in which the response level was high (e.g., greater than a predetermined number of responses and/or in less than a predetermined time period) may be aggregated to indicate the level of influence.

In one or more implementations, system 101 determines the authenticity of the first user's influence, and the level of influence is adjusted based on the determined authenticity. The authenticity may be based on, for example, the first user's interest in the product to be recommended, measured by social activity related to the product within the social network, and the frequency of that social activity. For example, the social activity may include one or more endorsement of the product. System 101 may measure endorsements of the product to determine the strength of the user's interest. The strength of the user's interest may also be based on the existence of other interactions that indicate an endorsement of competing products.

In block 302, purchase decisions made by social network users are correlated with social endorsements related to products in a product category to evaluate consumer responsiveness to the product category. In this regard, system 101 may identify the social endorsements from social activity viewable by the social network users, and then identifying a plurality of the purchasing decisions that were made in response to the social endorsements. Purchasing decisions may include navigating to an online retail website to purchase the product, clicking on an online advertisement, making an online or real world purchase through an online payment service, and the like. Purchasing decisions may be identified through browser activity, cookies, user information provided by consumer websites, and the like. In some implementations, if the purchasing decisions were made within a predetermined period of time from the endorsements then the purchasing decisions may be deemed by system 101 to have been caused, at least in part, by the endorsements.

In various aspects, the product category and the social activity generated by the first user are related to a predetermined area of interest (e.g., a SOI). In one or more implementations, consumer responsiveness may also be evaluated based on an amount of product advertisement activity generated for a group of users over a predetermined period of time. Product advertisement activity may include, for example, the number of advertisements for the product or product in the area of interest within a predetermined period of time, the number of advertisements placed or purchased by vendors within the predetermined period of time, the number of advertising keywords used in advertisement placement that relate to the product or area of interest, and the like.

In block 303, a value for a recommendation of a product in the product category by the first user is generated based on the first user's level of influence and the consumer responsiveness to the product category. The value may be a monetary value, a product discount (e.g., for the product), or other offering. The value may be calculated, for example, by a predetermined algorithm using as input one or more factors, including the first user's level of influence, consumer responsiveness to the product category, first user's interest in the product, and one or more second users' interest in the product category. As depicted by block 205 of FIG. 2, each factor may be individually weighted and calculated as a group of weighted factors in connection with the algorithm.

In one or more implementations, the recommendation may be directed to one or more second users. Accordingly, the one or more second users' interest in the product category may also be determined based on social activity related to the product category and initiated within the social network by the one or more second users, and the value generated based on the one or more second users' interest in the product category

In block 304, the value is provided to a vendor of the product. In one or more implementations, the value is provided to the vendor in a user interface (e.g., vendor auction interface 116) together with values of recommendations of the product from other users. The user interface may display the first user and other users and corresponding values for recommendations of the product by the first and other users for selection by the vendor. Accordingly, a respective user selected within the user interface is rewarded according to respective value for a recommendation of the product by the selected user within the social network.

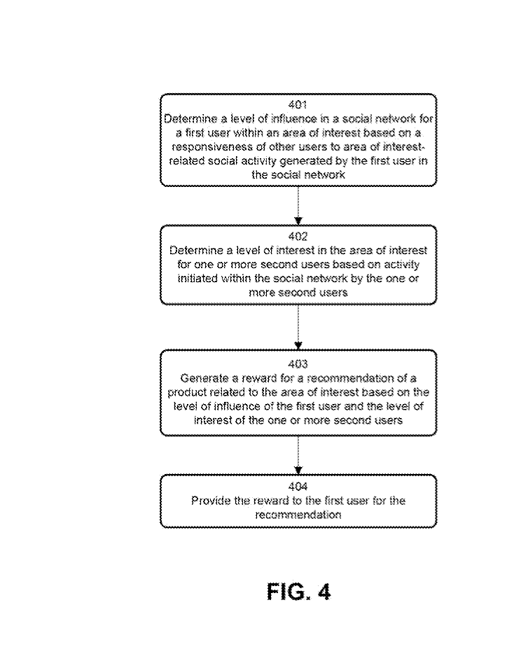

FIG. 4 is a flowchart illustrating, a second example process for pricing product recommendations in a social network, according, to one or more aspects of the subject technology. The blocks of FIG. 4 do not need to be performed in the order shown. It is understood that the depicted order is an illustration of one or more example approaches, and are not meant to be limited to the specific order or hierarchy presented. The blocks may be rearranged, and/or or more of the blocks may be performed simultaneously.

According to one or more implementations, one or more blocks of FIG. 4 may be executed by one or more computing devices implementing system 101, including social pricing engine 102 and/or auction engine 103. Similarly, a non-transitory machine-readable medium may include machine-executable instructions thereon that, when executed by a computer or machine, perform the blocks of FIG. 4.

In block 401, a level of influence in a social network for a first user within an area of interest is determined based on a responsiveness of other users to area of interest-related social activity generated by the first user in the social network. The level of influence may be determined according to any of the previously described methods described herein. In block 402, a level of interest in the area of interest for one or more second users is determined based on activity initiated within the social network by the one or more second users. In this regard, the level of interest may be determined by social pricing engine 102 in the same manner as consumer interest score 110, or may be the equivalent of consumer interest score 110 for the one or more second users.

In block 403, a reward is generated for a recommendation of a product related to the area of interest based on the level of influence of the first user and the level of interest of the one or more second users, and, in block 404, the reward is provided to the first user for the recommendation. A representation of the reward may be provided to the first user in a user interface (e.g., user auction interface 115) together with representations of other rewards for recommendations of other products. The user interface may display respective products and corresponding rewards for selection by the first user. Selection of a respective reward initiates a recommendation of a corresponding product within the social network by the first user.

The reward may be provided prior to after the recommendation is made. In one or more implementations, the recommendation may he automatically generated and made when the reward is selected by the first user. Initiation of the reward may also include, for example, reserving the reward for the user. When the user makes the recommendation, an indication is sent to auction engine 103 to inform the auction engine that the recommendation has been made, and the reward is distributed by auction engine 103 on receiving the indication.

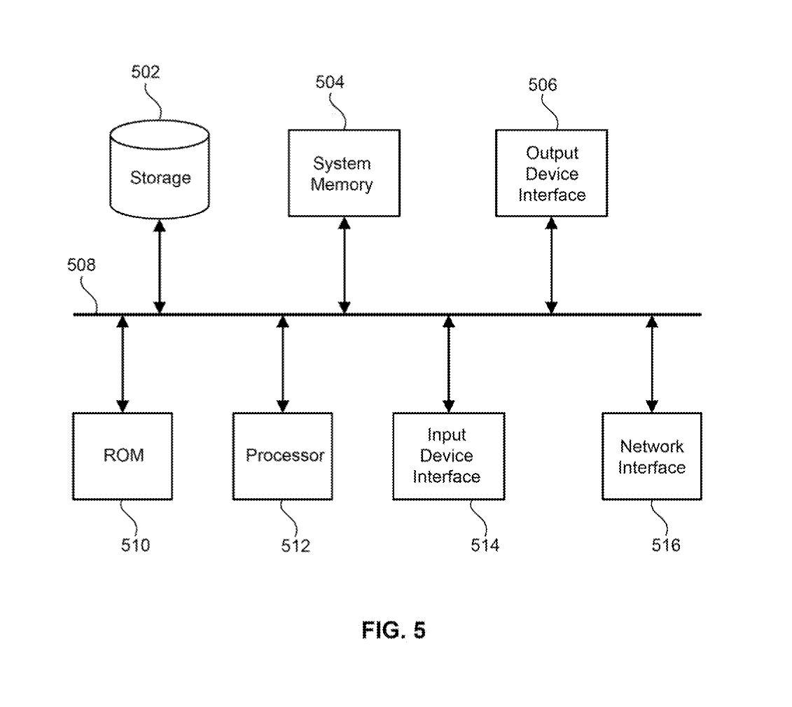

FIG. 5 is a diagram illustrating an example electronic system 500 for use in connection with pricing product recommendations in a social network, according to one or more aspects of the subject technology. Electronic system 500 may be a computing device for execution of software associated with the operation of social pricing engine 102, auction engine 103, storage device 104, or other component of system 101. Electronic system 500 may implement (e.g., by execution of the software) the processes described by FIG. 3 and FIG. 4. In various implementations, electronic system 500 may be representative of a server, computer, phone, PDA, laptop, tablet computer, touch screen or television with one or more processors embedded therein or coupled thereto, or any other sort of electronic device.

Electronic system 500 may include various types of computer readable media and interfaces for various other types of computer readable media. In the depicted example, electronic system 500 includes a bus 508, processing unit(s) 512, a system memory 504, a read-only memory (ROM) 510, a permanent storage device 502, an input device interface 514, an output device interface 506, and a network interface 516. In some implementations, electronic system 500 may include or be integrated with other computing devices or circuitry for operation of the various components and processes previously described.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted, to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing, system that includes a back end component, e.g., as a data server, or that includes middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic, hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for pricing a product recommendation made in a social network, comprising:
receiving, by one or more computing devices via a first user interface displayed at a first device remote from the one or more computing devices, an indication that a first user is interested in making a product recommendation;
determining, by the one or more computing devices responsive to the indication, a plurality of user contacts having a social connection to the first user in the social network that are interested in a predetermined product category based on historical data of online activities of the plurality of user contacts;
determining, by the one or more computing devices, a level of influence for the first user of the social network in the product category based on a responsiveness of the plurality of user contacts to social activity generated by the first user for the product category in the social network;
generating, by the one or more computing devices, a consumer responsiveness score for the product category based on correlating purchase decisions made by social network users in the product category with social endorsements related to products in the product category, wherein a first product and at least one different product are in the product category;
generating, by the one or more computing devices, a value for a social recommendation of the first product in the product category by the first user based on the first user's level of influence and the consumer responsiveness score; and
providing, by the one or more computing devices to a second user interface, a representation of the first user and the generated value for display to a vendor of the first product in connection with a display of a listing of users available to recommend the first product, wherein the second user interface is displayed at a second device remote from the one or more computing devices and the first device.

2. The computer-implemented method of claim 1, further comprising:
measuring the first user's interest in the first product based on the first user's social activity related to the first product within the social network, the value being generated based on the first user's interest in the first product.

3. The computer-implemented method of claim 2, wherein the first user's interest is measured based on a frequency of the first user's social activity related to the first product during a predetermined period of time.

4. The computer-implemented method of claim 2, wherein the social recommendation is directed to one or more second users, the method further comprising:
determining the one or more second users' interest in the product category based on social activity related to the product category and initiated within the social network by the one or more second users, the value being generated based on the one or more second users' interest in the product category.

5. The computer-implemented method of claim 4, wherein the value of the social recommendation is calculated by a predetermined algorithm using as input the first user's level of influence, consumer responsiveness score, first user's interest in the first product, and one or more second users' interest in the product category.

6. The computer-implemented method of claim 2, wherein measuring the first user's interest in the first product comprises:
measuring social interactions of the first user that indicate an endorsement of the first product.

7. The computer-implemented method of claim 6, wherein measuring the first user's interest in the first product further comprises:
determining a strength of the social interactions based on an existence of other interactions of the first user that indicate an endorsement of competing products.

8. The computer-implemented method of claim 1, wherein the product category and the social activity generated by the first user are related to a predetermined area of interest.

9. The computer-implemented method of claim 1, wherein correlating purchase decisions made by social network users with social endorsements related to the product category comprises:
identifying the social endorsements from social activity viewable by the social network users; and
identifying a plurality of the purchasing decisions that were made in response to the social endorsements.

10. The computer-implemented method of claim 1, wherein the consumer responsiveness score is generated based on an amount of product advertisements in the product category that is generated for a group of users over a predetermined period of time.

11. The computer-implemented method of claim 1, wherein the listing of users available to recommend the first product comprising a listing of a plurality of other users, the second user interface displaying the first user and the other users and corresponding values for recommendations of the first product by the first user and the other users for selection by the vendor, wherein a respective user selected within the second user interface is rewarded according to respective value for a recommendation of the first product by the selected user within the social network.

12. A machine-readable medium having instructions stored thereon that, when executed, cause a machine to perform a method, the method comprising:
receiving, by one or more computing devices via a first user interface, an indication that a first user is interested in making a product recommendation;
determining, by the one or more computing devices responsive to the indication, a plurality of user contacts having a social connection to the first user that are interested in a predetermined product category based on historical data of online activities of the plurality of user contacts;
determining, by the one or more computing devices, a level of influence in a social network for the first user within an area of interest based on a responsiveness of the plurality of user contacts to area of interest-related social activity generated within the area of interest by the first user in a social network;
generating, by the one or more computing devices, a consumer responsiveness score for the product category based on correlating purchase decisions made by social network users in the product category with social endorsements related to products in the product category, wherein a first product and at least one different product are in the product category, the product category being related to the area of interest;
generating, by the one or more computing devices, a reward for a social recommendation of the first product by the first user based on the first user's level of influence and the consumer responsiveness score; and
providing, to a second user interface by the one or more computing devices, a representation of the first user and the generated reward to the first user for the social recommendation for display in connection with a display of a listing of users available to recommend the first product.

13. The machine-readable medium of claim 12, the method further comprising:
measuring the first user's interest in the first product based on the first user's social activity related to the first product within the social network;
wherein the reward is based on the first user's interest in the first product.

14. The machine-readable medium of claim 13, wherein the first user's interest in the first product is measured based on a frequency of the first user's social activity related to the first product during a predetermined period of time.

15. The machine-readable medium of claim 13, wherein the social recommendation is directed to one or more second users, the method further comprising:
determining the one or more second users' interest in the product category based on product category-related social activity initiated within the social network by the one or more second users, the reward being based on the one or more second users' interest in the product category.

16. The machine-readable medium of claim 15, wherein the reward is generated by using the first user's level of influence, consumer responsiveness to the product category, first user's interest in the first product, and one or more second users' interest in the product category in a predetermined algorithm.

17. The machine-readable medium of claim 12, wherein correlating purchase decisions made by social network users with social endorsements related to the product category comprises:
identifying the social endorsements from social activity viewable by the social network users; and
identifying a plurality of the purchasing decisions that were made in response to the social endorsements.

18. The machine-readable medium of claim 12, wherein the consumer responsiveness score is generated based on an amount of product advertisements in the product category that is generated for a group of users over a predetermined period of time.

19. The machine-readable medium of claim 12, wherein a representation of the reward is provided to the first user in a user interface together with representations of other rewards for recommendations of other products, the user interface displaying respective products and corresponding rewards for selection by the first user, wherein selection of a respective reward initiates a recommendation of a corresponding product within the social network by the first user.

20. A computer-implemented method for pricing a product recommendation made in a social network, comprising:
receiving, by one or more computing devices via a first user interface, an indication that a first user is interested in making a product recommendation;
determining, by the one or more computing devices responsive to the indication, a plurality of user contacts having a social connection to the first user in the social network that are interested in a predetermined product category based on historical data of online activities of the plurality of user contacts;
determining a level of influence in a social network for the first user within an area of interest based on a responsiveness of the plurality of user contacts to area of interest-related social activity generated within the area of interest by the first user in the social network;
determining a level of interest in the area of interest for one or more second users based on activity initiated within the social network by the one or more second users;
generating, by the one or more computing devices, a consumer responsiveness score for the product category based on correlating purchase decisions made by social network users in the product category with social endorsements related to products in the product category, wherein a first product and at least one different product are in the product category, the product category being related to the area of interest;
generating a reward for a social recommendation of the first product related to the area of interest based on the level of influence of the first user and the level of interest of the one or more second users and the consumer responsiveness score; and
providing the reward to the first user for the social recommendation.

21. The computer-implemented method of claim 1, wherein a first purchasing decision of the purchasing decisions is associated with the first product and a second purchasing decision of the purchasing decisions is associated with at least one competing product in the product category, wherein the social endorsements are associated with a plurality of different products in the product category, and wherein the product category comprises multiple brands.
